(19) United States
(12) Patent Application Publication
(10) Pub. No.: US 2001/0049031 A1
(43) Pub. Date: Dec. 6, 2001

(54) GLASS SUBSTRATE FOR MAGNETIC MEDIA AND METHOD OF MAKING THE SAME

(76) Inventors: CHRISTOPHER H. BAJOREK, LOS GATOS, CA (US); MICHAEL C. TOLLE, MENLO PARK, CA (US)

Correspondence Address: DANIEL L. OVANEZIAN, BLAKEY, SOKOLOFF, TAYLOR, ZAFMAN LLP, 12400 WILSHIRE BOULEVARD, SEVENTH FLOOR, LOS ANGELES, CA, 90025, US

(21) Appl. No.: 09/262,365

(22) Filed: Mar. 4, 1999

(51) Int. Cl. G11B 5/82

(52) U.S. Cl. 428/694 ST

(57) ABSTRACT

A glass substrate and method for making the substrate. A sheet of glass is formed by floating molten glass on a molten material such as tin. The sheet is cut into smaller pieces which are then cut into circular blanks. An inner opening is formed in the blank. Other steps such as sizing cuts and chamfering of the inner and outer diameter may be performed. The blanks are ground or polished only a minimal amount or are not ground or polished, thus providing for economical manufacture. Various cleaning and chemical treatment steps may also be performed.

### FIELD OF THE INVENTION

The present invention relates to hard disk drives used to store data, and more particularly to a glass substrate for disks incorporated in disk drives and a method of making the substrate.

### BACKGROUND OF INVENTION

In the field of hard disk storage systems, the substrates on which magnetic recording media are fabricated to form a hard disk have, for most disk drive applications traditionally been made of aluminum or an aluminum alloy. The aluminum is typically coated with a plated nickel alloy layer, such as nickel phosphorus (NiP) for hardness because aluminum is a relatively soft material.

Recently, there has been considerable effort to use glass substrates more extensively (herein, the term “glass” will be used to denote any glass containing or derived material including amorphous glass and glass ceramic). It is desirable to use glass as a substrate material because it is more resistant to deformation upon sudden head slap by the recording head than NiP plated aluminum. In fact, for this reason glass substrates are currently frequently used for laptop or notebook computers. In addition, glass substrates typically have fewer thermal asperities due to embedded particles than aluminum substrates. Glass also has greater stiffness than aluminum, which provides for lower flutter due to lower vibration, thereby allowing for a greater number of tracks per inch and hence greater density. The lower flutter also allows for greater rotational speeds during drive operation, providing a lower access time and greater data transfer rate.

Glass substrates may be fabricated in a variety of ways. FIG. 1 illustrates an exemplary process flow for forming glass substrates. First, in step 101, a glass blank is formed. In one method, the glass is cast or pressed to form the blank. In this method, molten glass is poured into a cylindrical mold. The molten glass is then pressed and cooled to solidify. Next, an inner diameter (ID) opening is formed in the center of the blank.

In another method, molten glass is drawn from a molten pool of glass through rollers, then cooled and cut to form sheets of glass. The sheet may then be diced into smaller square, rectangular or similarly shaped pieces. Each piece is then typically “cored” or cut into cylindrical blanks, having an ID opening, in one or more cutting processes. In the coring process both the outside diameter (“OD”) and the ID are coursely sized.

Finally, in a further blank forming process, molten glass may be floated on, e.g. molten tin, to form a thin layer of molten glass. The molten glass is then cooled to form a sheet. The sheet is processed in roughly the same manner as the drawn glass described above to form the blank.

A representative blank 200 is shown in FIG. 2. The ID opening is not shown in FIG. 2. The blank 200 has an initial, as formed thickness shown as 200t. Eventually, in the steps outlined below, a substrate 210 having a thickness 210t will be formed. Typically, about 20% to more than 50% of the thickness 200t of blank 200 will be removed to form substrate 210. While the terms “substrate” and “blank” may sometimes be used to refer to the workpiece at a certain point in manufacture, usage may vary. For example, the term “blank” may be used as early as when the material is first formed in a cylindrical shape, and thereafter used to describe the material at other stages, such as rough cut, chamfering, edge polish, etc. The term “substrate” may be used to refer to the workpiece as early as after the polishing step(s) described below, and thereafter may be used to describe the workpiece (including any layers or features formed in or on the workpiece) at any point during the manufacture of the magnetic recording media. It will be appreciated that use of the terms “blank” or “substrate” herein will usually refer to the workpiece as it exists at the point under discussion, depending upon the context. However, use of either term in no way limits the workpiece or the scope of the invention to any specific point in the sequence or to any state of the workpiece as many different process steps can be carried out in a different order than described herein, may be not be used in every circumstance, or may be replaced with different and/or additional process steps.

After forming a blank, the glass may undergo thermal treatment in step 102. The thermal treatment anneals out stress and can assist in flattening the blank. Then, step 103 comprises a grinding operation wherein the OD and ID edges are ground to precisely size the ID and OD, and to provide a chamfer. Because the disk is considerably thicker than the final substrate, the grinding operation must be designed such that the desired chamfer will be present in the finished substrate. After the grinding operation, the edges may be polished, if necessary, to a smoothness sufficient to allow handling with robotics, holding in clamps and like operations, without damage to either the disk or such equipment and without generation of debris.

The edge polish may be followed by some combination of grinding, lapping and polishing steps. Although usage of these terms vary, grinding typically refers to a primarily physical process where the blank is pressed against a grinding stone, or a plate with embedded particles such as diamond particles, in the presence of a lubricant or coolant. Grinding is a relatively aggressive step in that a large amount of material is removed quickly. In this step, large defects and large scale (i.e. long wavelength) surface level variations are removed or greatly reduced. However, smaller defects and smaller scale surface level variations remain.

Polishing and lapping normally refer to steps that are both chemical and physical, but for glass substrates are usually primarily chemical. In these steps, the blank is placed between two cloth polishing pads that contain a slurry having an etchant (such as cerium oxide) and an abrasive. These steps are carried out using successively less aggressive processing (successively smaller sized abrasives and/or less aggressive chemistries and/or lower pad pressure). In this way, progressively smaller defects and surface level variations are removed, resulting in a very smooth, low defect level surface. Although lapping and polishing can use the same type of equipment and slurries, the term lapping is typically used for a more aggressive process. In fact, in some cases no grinding is performed and a large amount of material is instead removed by one or more lapping steps. In contrast, the polishing steps typically remove a minor amount of material, and are primarily performed to cause the surface to be free of small defects and impurities, and to form a very smooth surface.

In the exemplary prior art process of FIG. 1 after step 103, a first grinding process 104 is performed, followed by a second grinding process 105. Returning to FIG. 2, portions 201 and 202 are removed from both sides of blank 200 by grinding processes 104 and 105 respectively. It will be appreciated that the figures herein while illustrative, are not necessarily drawn to scale. As can be seen, these two grinding processes have removed the bulk of the total material to be removed. As mentioned earlier, one or both of the grinding steps may be replaced with one or more aggressive lapping steps. In any event, approximately 80% to 95% or more of the total thickness to be removed is removed in the grinding and/or lapping steps prior to polishing.

Returning to FIG. 1, following the grinding steps a polish 1 step 106 is performed followed by a polish 2 step 107. As with the grinding and/or lapping steps, the polish steps are performed such that each step is successively less aggressive and removes a smaller amount of material. In FIG. 2, the portion 205 removed from both sides of substrate 200 by both polishing steps 106 and 107 is shown. The polishing steps combined remove the remaining material to be removed to form a substrate 210—i.e., approximately 5-20% of the total material to be removed, which is typically an amount equal to about 1-10% of the total thickness 200t. Of the total amount 205 removed in the polishing steps, most (e.g. approximately 85%) is removed in the polish 1 step 106 in standard glass substrate manufacturing processes. Stated alternatively, typically about 1-10% of the total thickness 200t may be removed in the polish 1 step 106, while about 0.1-1% of the total thickness 200t may be removed in the polish 2 step 107. Of course, the actual amount removed in each grinding, lapping or polishing step may vary from the foregoing in different processes.

After the final polishing step 107, the blank is cleaned in step 108 and then in the case of amorphous glass chemically strengthened in step 109. In step 109, one or more chemicals such as sodium nitride and potassium nitride are implanted in the surface of the substrate by immersion in a high temperature solution to cause the surface layer to be in compressive stress, preventing cracks from propagating. Finally, the disk is once again cleaned in step 110.

Many different variations of the exemplary process of FIG. 1 may be used, including the addition of grinding or lapping steps or replacement of one or more grinding steps with lapping steps. In that regard, a large amount of material is typically removed in one or more grinding and/or lapping steps, while a relatively small amount of material is removed in one or more polishing steps to form a smooth finish and remove small scale surface level variations and other irregularities. If desired, there may be one or more cleaning steps between successive polishing or successive grinding/lapping steps in addition to those shown, while one or more of the clean steps shown may not be performed.

Additionally, other steps may be omitted or performed at different stages of the process. As one example, the grinding and polish of the edges in step 103 may be performed at a different point in the process, although it is typically desired to perform these operations before the polish steps so that they do not damage the polished surfaces of the disk. Additionally, these operations need not be carried out in sequence and each may be placed at a different point in the process.

One significant disadvantage to glass substrates is the increased cost as compared with aluminum substrates. Of the total cost to produce a substrate, the grinding, lapping, and polishing steps usually comprise two thirds of the cost or more. Often, this cost is roughly equally split between the grinding/lapping and polishing steps, but of course may vary depending upon the extent each is performed.

What is needed is a process for forming a glass substrate that is economical, while resulting in a smooth surface, free of asperities, scratches, embedded particles or other defects and free of contaminants.

### SUMMARY OF THE INVENTION

A method of making a glass substrate, and the resulting substrate are described. First, molten glass is floated on a molten material. The glass is solidified into a sheet which is sectioned and cored to form a cylindrical glass blank having an inner diameter hole. In some embodiments no more than about 10% of the total thickness of the blank is removed in polishing or lapping or grinding operations. In other embodiments even smaller amounts of material are removed. Finally, in some embodiments no grinding, polishing or lapping steps are performed.

Other operations such as sizing, chamfering, and polishing of the edges are performed. In addition, various cleaning steps may be used throughout the process.

Additional embodiments and other features and advantages of the present invention will become apparent from the detailed description, figures and claims which follow.

### BRIEF DESCRIPTION OF THE DRAWINGS

FIG. 1 shows a block diagram of an exemplary prior art process.

FIG. 2 illustrates the material removed from a blank to form a substrate in the prior art process shown in FIG. 1.

FIG. 3 shows results of EDX analysis of two sides of an as-floated glass blank formed according to the present invention.

FIG. 4 illustrates SIMS analysis of a glass blank formed according to the present invention.

FIGS. 5A-5C show block diagrams of embodiments of the present invention.

FIG. 6 illustrates the material removed from a blank to form a substrate according to one of the embodiments of FIG. 5.

### DETAILED DESCRIPTION

Methods of making a substrate, magnetic recording media, and storage devices, as well as the substrate, media and storage devices, are disclosed. In the following description, numerous specific details are set forth such as specific dimensions, materials, operating parameters, processes, physical characteristics, etc. It will be appreciated, however, that these specific details need not be employed to practice the present invention. In other instances, well known methods and apparatuses are not described in detail in order not to obscure unnecessarily the present invention.

Advanced media requires an extremely smooth surface. Generally, the roughness or variation in surface level may vary from small scale variation over distances such as a few nanometers, up to large scale variations over a distance of up to several millimeters. In general, such variations are classified in terms of the wavelength of the variation. Roughness measurements will depend not only upon the wavelength bandwidth selected but also upon the definition of roughness. For example, two well known measures of roughness include the arithmetic average of the distance of the peaks and valleys above and below, respectively, the average surface level (Ra roughness), and the root means square average of such variations (RMS roughness). In addition, the roughness value will depend upon the particular type of system used to measure roughness as well as the various parameters that may be used in operating the system and the particular method by which the system calculates roughness.

Although terminology may vary greatly, and although both Ra and RMS calculations may be performed for roughness in any wavelength range, the term “Ra roughness” by itself as used in the disk drive industry typically refers to roughness measured in the wavelength range of approximately under 0.1 micron (μM)-10 μm. RMS roughness may typically be measured at a slightly greater wavelength range such as approximately below 1 μm-50 μm. On the other end of the scale, the term flatness is often used to refer to surface level variations having a wavelength on the order of several hundred microns to several tens of millimeters. In between, other ranges of wavelength may be examined such as, for example, as “low frequency” roughness which is used to denote Ra roughness measured at greater wavelength (e.g. tens to hundreds of microns) than that used when Ra roughness is specified.

In state of the art devices using a polished nickel phosphorous layer the Ra roughness as measured by atomic force microscope (AFM) is on the order of approximately 2.5 Angstroms (Å) or less. The low frequency roughness, as measured by a Zygo New View system using a high pass FFT-type fixed filter, with a wavelength of 250 μm and a 300×240 pixel scan size is typically approximately 6 Å or less. Finally, the flatness as measured on a Phaseshift Optiflat using a flyable radius between 14 mm and 47 mm is typically in the range of approximately 4 μm or less.

As mentioned in the Background section, glass blanks are formed to a much greater thickness than the ultimate substrate, to allow for extensive grinding, lapping and polishing to ensure that the various surface characteristics described above are acceptable for advanced devices. For example, to form a substrate having a thickness of 1 mm, the blank may be formed having a thickness of approximately 1.2 mm-2 mm or greater, so that a couple hundred to one thousand or more microns of material is removed. In addition, with respect to floated glass it is further believed that extensive material must be removed to ensure no contamination from the material (e.g. tin) that the glass is floated on.

In contrast to the prior art understanding, it has been discovered that as-floated glass has excellent surface characteristics. For example, in one sample the Ra roughness measured by AFM was found to be approximately 1.3 Å. The low frequency roughness as measured on a Zygo New View using the previously described recipe was approximately 4 Å. Finally, the flatness, as measured by a Phaseshift Optiflat using the above-described flyable radius was approximately 6 μm. Thus, the result of this investigation shows that, contrary to the common understanding, the surface quality of the as-floated material is extremely good.

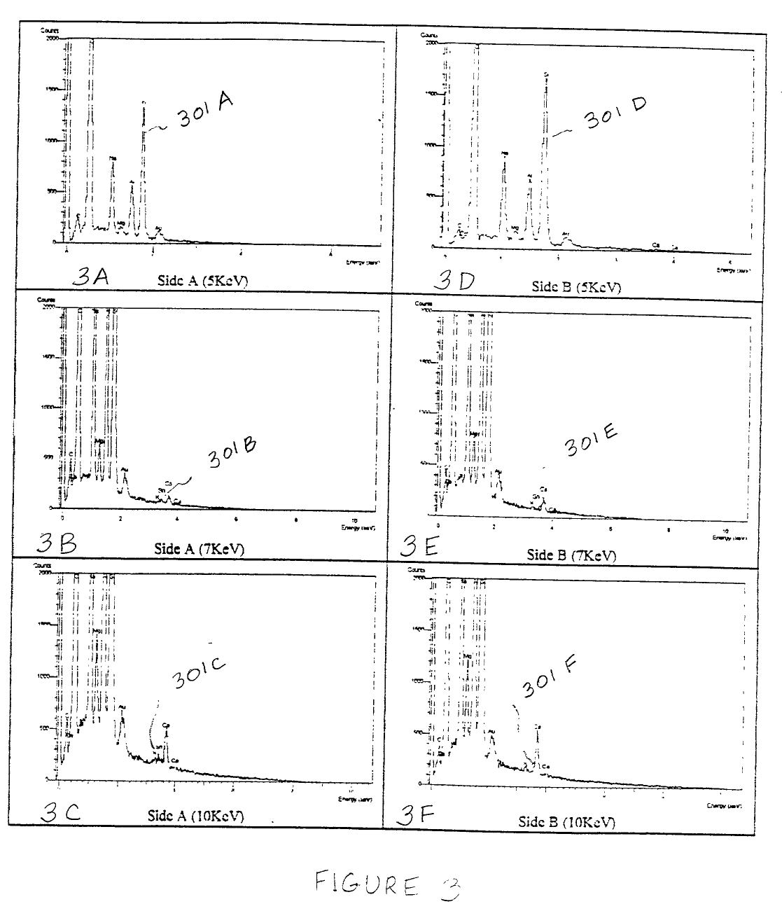

FIGS. 3A-3C show the results of EDX analysis on a first side of floated glass at three different accelerating voltages. FIGS. 3A-3C show results from the side in contact with the molten tin. Referring to FIG. 3A, at an accelerating voltage of 5,000 electron volts (5 KeV), peak 301A shows the presence of some amount of tin. Although some amount of tin is present on or near the surface, the amount is small as evidenced by the small peak heights. Referring now to FIGS. 3B and 3C, EDX results performed at 7 KeV and 10 KeV, respectively, are shown. Because of the greater accelerating voltage, these figures represent the concentration of materials at successively greater depths. It can be seen from peaks 301B and 301C of FIGS. 3B and 3C that the tin concentration is negligible at greater depths.

Referring now to FIGS. 3D-3F, the results of EDX analysis of the opposite side of the as-floated glass (the side not in contact with the molten tin) at 5 KeV, 7 KeV and 10 KeV are shown. As can be seen from peak 301D, there is some concentration of tin near the surface. However, at greater depths, as shown by peaks 301E and 301F the concentration of tin at greater depths is negligible. As a point of clarification, in FIGS. 3C and 3F the tin peak is relatively small and the large peak immediately to the right of the tin peak is due to the element calcium.

As described above, it is generally believed that tin diffuses into the floated glass at the interface, thus requiring that material be removed from the blank to prevent tin contamination in the fabrication of magnetic media. However, by comparing 3A-3C and 3D-3F it can be seen that the behavior of both sides of the glass i.e. the side in contact with the tin as well as the side that is not in contact with the tin is essentially equivalent. Thus, while some tin may reside on or near the very surface of the glass, a result of the analysis of FIG. 3 is the discovery that there is not significant tin diffusion into the glass by virtue of the molten tin/molten glass interface.

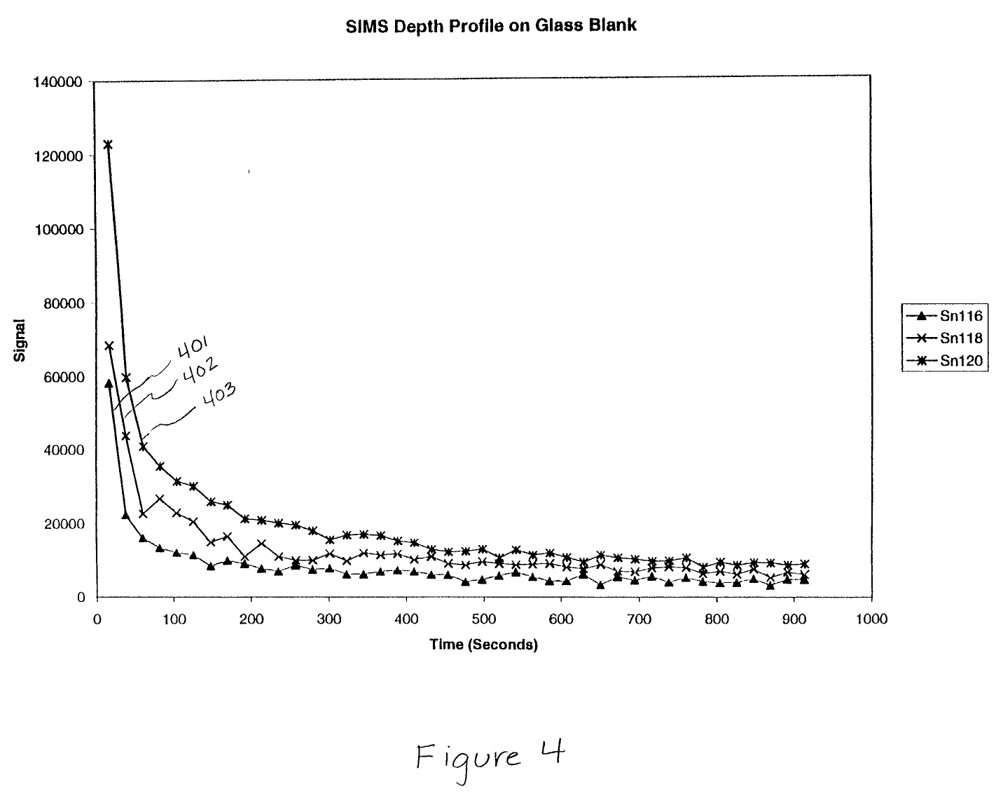

FIG. 4 shows a secondary ion mass spectroscopy analysis on an as-floated glass blank. The Y-axis shows the ion counts and the X-axis represents the time that the beam was held stationary at the point of incidence, in seconds. By keeping the beam stationary, a hole is drilled into the substrate, so that the analysis reveals the tin content as a function of depth. An examination time of 900 seconds yielded a hole depth of approximately 900 Å. If a linear drilling rate is assumed, the signal versus time plot is equivalent to a signal versus depth (in Angstroms) profile. Curves 401, 402 and 403 show the signal for three different isotopes of tin, specifically Sn 116, Sn 118 and Sn 120, respectively. As can be seen from FIG. 4 virtually all of the tin resides in the first 100 Å or less of the surface. It should be noted that even the amounts of tin present near the surface are not significant. Nevertheless, the signal drops off extremely rapidly indicating that the relatively small tin content is primarily is in the first hundred Angstroms or so near the surface.

Based upon the discovery of the lack of significant tin diffused into as-floated glass and the high quality of the surface, the present invention comprises the use of as-floated glass as the substrate for magnetic recording media. The substrate may be formed in a process that does not utilize expensive grinding, lapping or polishing steps. Alternatively, these steps may be used in a very limited fashion to curtail costs.

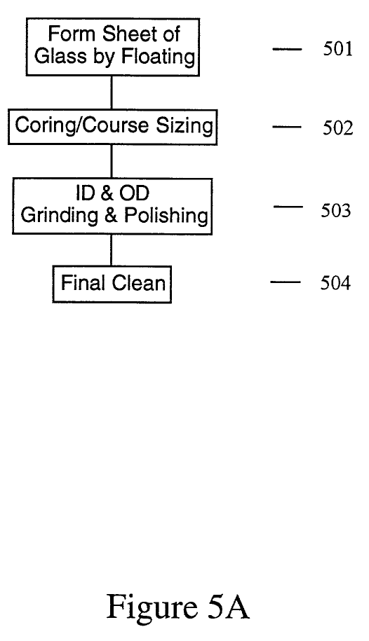

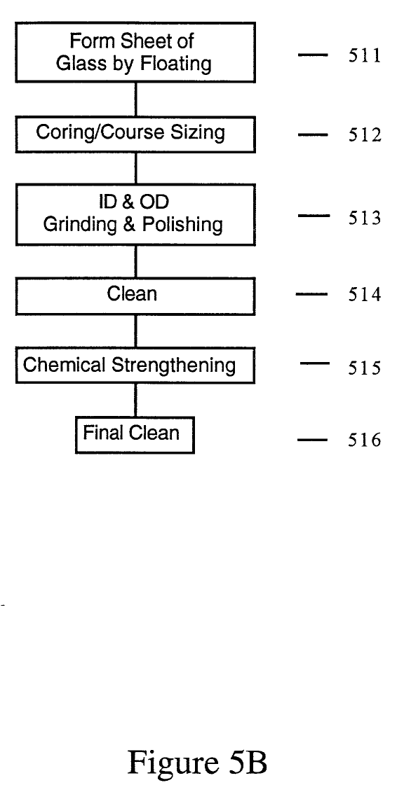

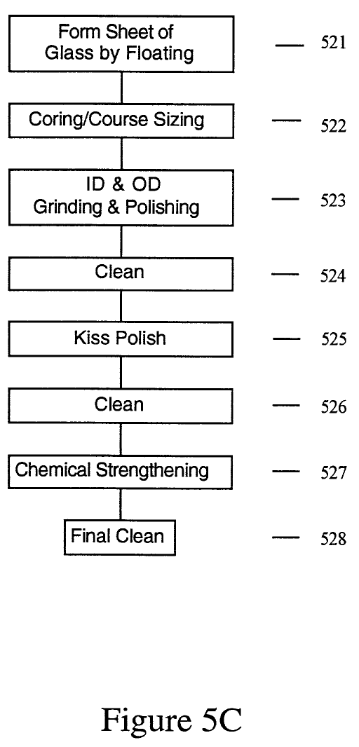

Referring to FIG. 5A, a flow diagram of an exemplary process according to the present invention is shown. In step 501 a sheet of glass is formed by floating. In this step, molten glass is floated on molten tin. The molten glass is cooled to form a sheet of glass. In this embodiment of the present invention, the molten glass is floated such that its thickness is substantially equal to the desired final substrate thickness. In step 502 the glass sheet is sectioned into smaller pieces, and then cored into cylindrical shaped blanks having an inner diameter opening. After this step, the ID and OD have been coursely sized.

Next, in step 503 inner diameter and outer diameter grinding is performed to provide a desired chamfer and to precisely size the ID and OD of the substrate. Because the blank is at or near its desired thickness in the embodiments of the present invention, the chamfer can be put on without extensive adjustment to account for subsequent extensive grinding, lapping and/or polishing operations. Because the amount of material removed after chamfering is not extensive, there is less affect on chamfer length due to side to side removal non-uniformity, thereby improving chamfer length uniformity. Next, an edge polishing may be performed to ensure that the edges are smooth. Then, in step 504 a final clean is performed.

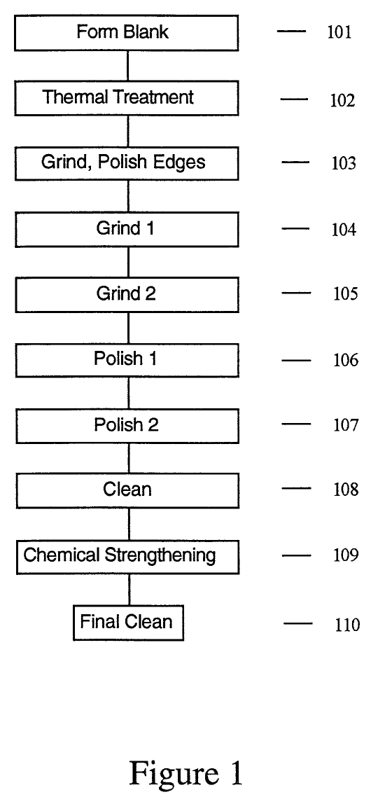

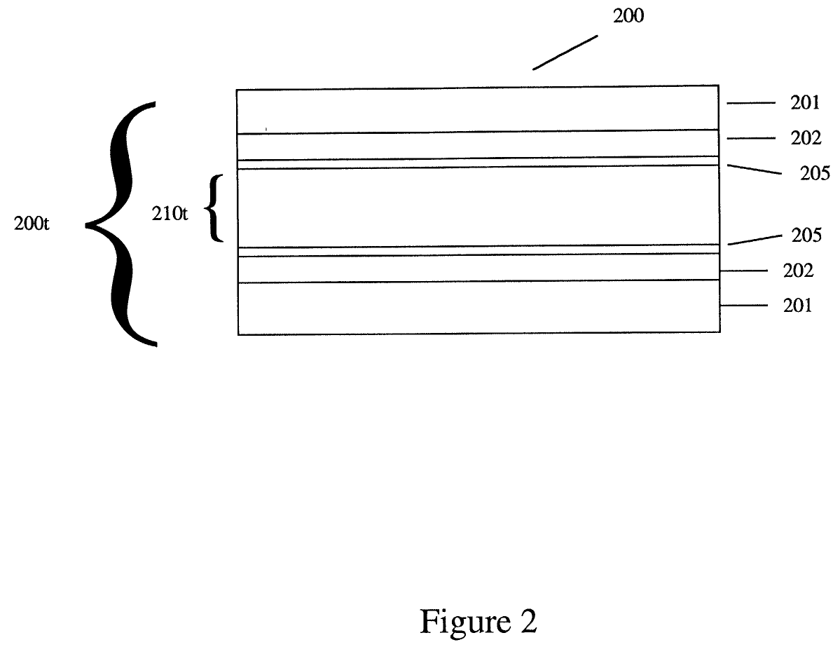

By comparing the process described in relation to FIG. 5A to that described in relation to FIG. 1, it can be seen that the process of the present invention is considerably less complex. Therefore, embodiments of the present invention, including that shown in FIG. 5A, provide the ability to fabricate glass substrates at a substantially reduced cost. For example, approximately one half to two thirds or more of the cost of fabricating a substrate may be eliminated with the present invention.

A further embodiment of the present invention is shown in FIG. 5B. In the embodiment shown in FIG. 5B, a sheet of glass is formed by floating in step 511, and then is sectioned and cored in step 512. ID and OD grinding and polishing is performed in step 513. Next, in step 514 a clean is performed. Then in step 515 a chemical strengthening step is performed to prevent propagation of micro-cracks. Next, in step 516 a final clean is performed. Again, the process of FIG. 5B is considerably less complex and costly than the prior art process of FIG. 1.

FIG. 5C shows a further embodiment of the present invention. A sheet of glass is formed by floating in step 521, sectioned and cored in step 522. ID and OD grinding and polishing is performed in step 523. Next, in step 524 a clean is performed on the blank.

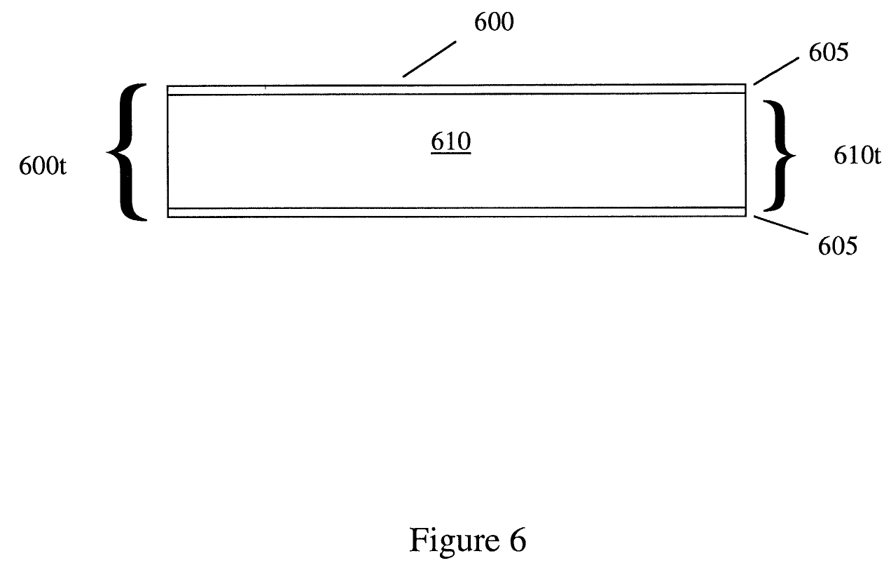

Referring briefly to FIG. 6, an illustration of blank 600 having a thickness 600t is shown (the ID opening is not shown in FIG. 6). Returning to FIG. 5C, after step 524 the blank may be polished in step 525. Because the surface of the as-floated glass is high quality and contains minimal tin, even in embodiments having one or more polish steps it is typically not necessary to perform extensive polishing. In fact, step 504 may be referred to as a “kiss” polish to indicate the non-extensive nature of this step. Referring to FIG. 6, a very thin layer 605 is removed in embodiments where the polishing process is performed. In general, where polishing is performed, a single polishing step may be used which will typically be similar to the final polishing step used in the prior art process.

Following the polish step 525, a cleaning step 526 may be performed followed by chemical strengthening step 527. Finally, in step 528 a cleaning is performed to complete processing of the substrate.

As described earlier, glass substrates have proven to be considerably expensive for use in recording media. Much of the expense is in the grinding, lapping and polishing steps. These steps are costly due to a variety of factors, including a cost of capital equipment, material usage, labor, and costs associated with increased through-put time. In embodiments where no grinding, lapping, or polishing steps are performed, these steps and therefore their costs are essentially eliminated. In the prior art, the steps combined typically remove at least 20% of the blank thickness and often 50% or more of the blank thickness. In contrast, in the present invention it is desirable to remove no more than 10 % of the thickness of the blank. For a 1 mm substrate, the initial blank thickness would therefore need be no more than approximately 1.1 mm, meaning that about 100μ or less of material is to be removed. Typically, less than 5% of the thickness of the blank is removed and more preferably 2.5% or less of the thickness of the blank in the present invention. In many cases, the thickness of the blank removed corresponds to only that removed in prior art final polishing steps which is typically less than about 1% of the thickness of the blank. By cutting down the extent of the grinding, lapping and polishing the cost of producing the blank can be significantly reduced.

Viewed alternatively, the present invention comprises performing only that amount of grinding, lapping or polishing necessary to fine tune the surface characteristics. For example, a minor amount of grinding or lapping may be performed to improve large scale flatness or micro-waviness. More typically, only a very fine polish is desirable to provide for a very fine surface in terms of removal of asperities, scratches, embedded particles or other minor defects, contaminants, and to provide a good degree of smoothness (i.e. low Ra). It will be appreciated that “removal” of a defect as used herein does not necessarily mean complete removal of all such defects, but rather removal to the level necessary for the media to be formed on the substrate.

Although the amount of tin on or in the first fraction of the substrate surface is small, this minor amount of tin will be removed by even a very light polishing. Alternatively, in embodiments in which no polish is performed, it may be desirable to design the cleaning process such that the tin is removed from the substrate surface by chemical action.

It will be appreciated that the process flows in FIGS. 5A-5C is merely exemplary, and some steps may be omitted if desired, or the steps may be performed in an order different from that shown in FIGS. 5A-5C. Additional steps, such as additional cleaning grinding, lapping or polishing steps or other steps, such as a thermal treatment step, may be added to any of the process flows of FIG. 5A-5C. However, by limiting the presence of grinding, lapping and/or polishing steps or the extent of any such steps if present the cost may be greatly reduced. Moreover, as is known polishing tends to produce roll-off (also referred to as “dub-off”) whereby the surface of the disk rolls off by several hundred angstroms prior to the beginning of the desired chamfer. By eliminating or greatly reducing the amount of polishing, the roll-off due to polishing is correspondingly eliminated or reduced.

It will be appreciated that in some instances a device utilizing a magnetic recording disk may have less rigorous requirements than the most demanding application. For example, devices with removable cartridges comprising one or more disks often are at lower densities than the most advanced non-cartridge drive. For use in these drives, as-floated glass is particularly suitable because a given quality of as-floated glass requires less processing than is required of the same material for use in the most advanced drive. Therefore, the present invention may find particular applicability in such drives.

While the invention has been described with respect to specific embodiments thereof, those skilled in the art will recognize that changes can be made in form and detail without departing from the spirit and scope of the invention. Although specific embodiments have been shown, aspects of any embodiment can be used in others. The embodiments described herein, as well as embodiments having changes in form and detail as may be readily apparent to one of skill in the art upon reading the present disclosure are understood to come within the scope of the present invention.

What is claimed is:

1. A method of making a substrate comprising the steps of:
floating molten glass on a molten material;
solidifying said molten glass to form a glass sheet;
forming at least one blank from said glass sheet, said blank having a thickness;
performing one or more operations to form a substrate, wherein said one or more operations remove 10% or less of said thickness of said blank to form said substrate.

2. The method as described in claim 1 wherein said one or more operations remove 5% or less of said thickness of said blank.

3. The method as described in claim 1 wherein said one or more operations remove 2.5% or less of said thickness of said blank.

4. The method as described in claim 1 wherein said one or more operations remove 1% or less of said thickness of said blank.

5. The method as described in claim 1 wherein said step of forming at least one blank comprises sectioning a portion of said sheet of glass and coring said sectioned piece, and wherein said method further comprises the steps of chamfering one or both of an outside diameter edge of said blank and an inside diameter edge of said blank, and polishing one or both of said outside diameter edge and said inside diameter edge of said blank.

6. The method as described in claim 1 when no grinding, lapping or polishing operation is performed to form said substrate.

7. The method as described in claim 1 further comprising a polishing operation, said polishing operation effective to achieve one or more of:
removal of embedded particles;
removal of asperities;
removal of scratches;
removal of chemical contaminants on or near the surface;
lowering the roughness of said surface; and
any combination of the foregoing.

8. The method described in claim 1 further comprising depositing one or more magnetic layers on said substrate to form a magnetic recording disk.

9. A substrate formed by a method comprising the steps of:
floating molten glass on a molten material;
solidifying said molten glass to form a glass sheet;
forming at least one blank from said glass sheet, said blank having a thickness;
performing one or more operations to form a substrate, wherein said one or more operations remove 10% or less of said thickness of said blank to form said substrate.

10. A disk drive comprising one or more of said magnetic recording disks formed by a method comprising of steps:
floating molten glass on a molten material;
solidifying said molten glass to form a glass sheet;
forming at least one blank from said glass sheet, said blank having a thickness;
performing one or more operations to form a substrate, wherein said one or more operations remove 10% or less of said thickness of said blank to form said substrate;
depositing one or more magnetic layers on said substrate to form a magnetic recording disk.

11. The disk drive as described in claim 10 wherein at least one of said one or more magnetic recording disks is contained in a removable cartridge.

12. A method of making a substrate comprising the steps of:
floating molten glass on a molten material;
solidifying said molten glass to form a glass sheet;
forming at least one blank from said glass sheet, said blank having a thickness;
wherein one or more of the operations selected from the group consisting of grinding, polishing and lapping, if any, are performed to the extent necessary to adjust the surface characteristics of said blank and not to remove bulk material from said blank.

13. The method as described in claim 12 wherein no grinding, lapping or polishing operation is performed to form said substrate.

14. The method as described in claim 11 wherein said one or more surface characteristics is selected from the group consisting of:
removal of embedded particles;
removal of asperities;
removal of scratches;
removal of chemical contaminants on or near the surface;
lowering the roughness of said surface; and
any combination of the foregoin.

15. The method as described in claim 14 wherein said surface has an Ra roughness of 2 Å or less after said one or more operations.

16. The method as described in claim 12 wherein said one or more operations remove no more than 10% of said thickness of said blank.

17. A substrate having a substrate thickness, said substrate formed from a blank, said blank having a blank thickness, wherein said substrate thickness is 90% or more of said blank thickness, said substrate comprising glass.
